(19) United States
(12) Patent Application Publication
(10) Pub. No.: US 2025/0272206 A1
(43) Pub. Date: Aug. 28, 2025

(54) ACTIVITY RECOGNITION ERROR DETECTION IN ACTIVITY SIGNAL EMBEDDING SPACE

(71) Applicant: HRL Laboratories, LLC, Malibu, CA (US)

(72) Inventors: Hyukseong KWON, Thousand Oaks, CA (US); Amir M. RAHIMI, Santa Monica, CA (US); Rajan BHATTACHARYYA, Sherman Oaks, CA (US)

(73) Assignee: HRL Laboratories, LLC, Malibu, CA (US)

(21) Appl. No.: 18/852,191

(22) PCT Filed: Mar. 30, 2023
(86) PCT No.: PCT/US2023/065152

§ 371 Date: Sep. 27, 2024

Related U.S. Application Data
(60) Provisional application No. 63/326,009, filed on Mar. 31, 2022.

(51) Int. Cl. G06F 11/30

(52) U.S. Cl. CPC G06F 11/3051; G06F 11/3072

(57) ABSTRACT

A computer system is disclosed for processing an activity class signal comprising a dominant activity class and a plurality of less dominant activity classes. A runtime activity class detector is trained to detect the dominant activity class in the activity class signal, and a false positive (FP) filter is configured to filter out FP classifications detected by the runtime activity class detector, wherein the FP filter is trained based on the less dominant activity classes in the runtime activity class signal.

### CROSS-REFERENCE TO RELATED APPLICATIONS

The present application claims priority to U.S. Provisional Application No. 63/326,009 entitled ACTIVITY RECOGNITION ERROR DETECTION IN ACTIVITY SIGNAL EMBEDDING SPACE filed on Mar. 31, 2022, the entirety of which is hereby incorporated by reference.

### TECHNICAL FIELD

This specification relates to activity recognition error detection.

### BACKGROUND

In applications of autonomous driving and surveillance systems, activity recognition is crucial to understand people's behaviors or intentions. There have been a number of research and developments in this area as illustrated in Ronald Poppe, “A survey on vision-based human action recognition,” Image and. Vision Computing 28 (6): 976-990 (2010) and S. Herath, M. Harandi and F. Porikli, “Going deeper into action recognition: A survey,” Image and Vision Computing, 2017. Also, deep-learning-based approaches are known for activity recognition as illustrated in S. Ji, W. Xu, M. Yang and K. Yu, “3D Convolutional Neural Networks for Human Action Recognition,” IEEE Transactions on Pattern Recognition and Machine Intelligence, 35 (1), 2013.

Scene graph based approaches are useful for describing relations between actions and the neighborhood objects. A method of generating scene graphs and converted into short-term features with a few second length to analyze the activity classes is described in João Carreira and Andrew Zisserman, “Quo Vadis, Action Recognition? A New Model and the Kinetics Dataset,” Proceedings of the IEEE/CVF Conference on Computer Vision and Pattern Recognition 2017:4724-4733. Also, it is known to extend the scene graph conversion into a long-term feature to cover longer and reliable activity recognition as described in Chao-Yuan Wu, Christoph Feichtenhofer, Haoqi Fan, Kaiming He, Philipp Krähenbühl and Ross B. Girshick, “Long-Term Feature Banks for Detailed Video Understanding,” Proceedings of the IEEE/CVF Conference on Computer Vision and Pattern Recognition 2019:284-293. The scene graphs may be expanded into a spatial and temporal way to explain more complicated activity situations as described in Ji, Jingwei, et al., “Action genome: Actions as compositions of spatio-temporal scene graphs,” Proceedings of the IEEE/CVF Conference on Computer Vision and Pattern Recognition 2020.

These scene graphs contain huge amount of irrelevant actions which may degrade accurate recognition outputs. An abstracted feature method to provide more precise activity recognition only with relevant information, is described in A. Rahimi, A. Agarwal, K. Lee, H. Kwon and R. Bhattacharyya, “Toward Improving the Visual Characterization of Sport Activities with Abstracted Scene Graphs,” IEEE Conference on Computer Vision and Pattern Recognition: Workshop on Computer Vision in Sports, 2021.

### DESCRIPTION OF DRAWINGS

FIG. 1 is an embodiment of a True Positive (TP)/False positive (FP) training system.

FIG. 2 is an embodiment of an activity recognition error detection and correction system.

FIG. 3 is a flow diagram according to an embodiment for generating a scene graph through feature abstraction.

FIGS. 4A and 4B illustrate sample result activity signals from a video clip showing classification of Activity 29.

FIG. 5 is an embodiment of a TP/FP training in an activity class embedding space.

FIGS. 6A and 6B illustrate TP/FP distributions in a class embedding space.

FIG. 7 is an embodiment of a false positive removal process with trained TP/FP models in an embedding space.

FIG. 8 is an embodiment wherein an activity class detector detects an activity class from an activity class signal (e.g., video signal), a false positive filter filters out false positive classifications, and a vehicle controller controls a vehicle based on the identified activity class.

### DETAILED DESCRIPTION

The disclosed embodiments detect activity recognition errors (false positives) once the recognition process is completed. The embodiments provide an approach to filter out false positive recognition results using less dominant activity classes in the activity signal embedding space. The framework of the statistically verified action recognition error estimation and correction may be determined by learning the less dominant activity class signals in the activity signal embedding space.

The embodiments describe an activity recognition error detection method with less dominant activity class signals in the activity embedding space. In one embodiment, a scene graph generation method, which includes detected objects and the corresponding relations, generates scene graphs. Then those scene graphs are abstracted to keep only relevant information. The abstracted scene graphs are mapped to the activity signal embedding space and the main dominant activity signal is suppressed. By training those adapted signals separately for true positive and false positive patterns in the activity signal embedding space, true/false positive distributions are determined for each activity class. For testing (as well as runtime), each scene graph is applied, and the activity signals in the embedding space are classified into true positive or false positive depending on Mahalonobis distances from the corresponding TP/FP distributions according to an embodiment. This process increases the precision rates of activity recognition with minor impacts on the recall rates.

Accordingly, one embodiment may be a computer implemented method to evaluate perception errors comprising:
(1) Activity perception information into the activity signal embedding space;
(2) Embedding space based statistical model on less dominant information from activity features; and
(3) Activity recognition error detection from the true positive/false positive distributions in the embedding space.

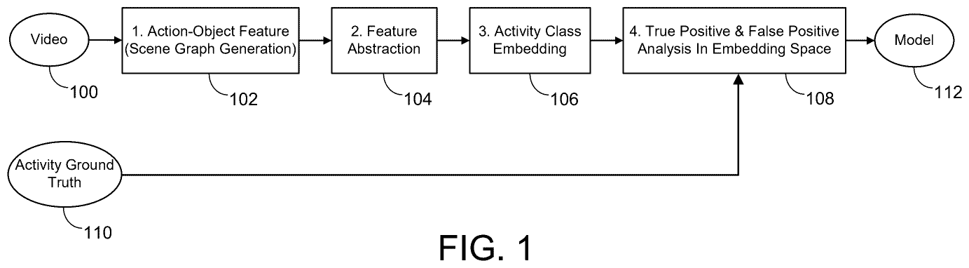

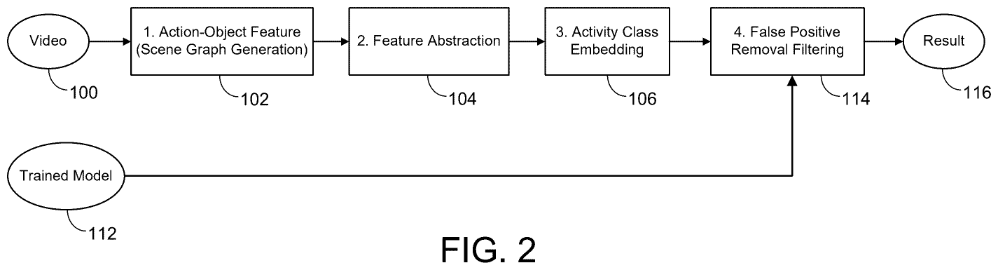

An embodiment for activity recognition error detection is illustrated in FIG. 1 and FIG. 2. FIG. 1 shows the training process according to an embodiment to generate true positive (TP)/false positive (FP) distributions in the activity class embedding space. From an input video (block 100), in Step 1 (block 102) a scene graph is generated in the action-object feature space. Step 2 (block 104) converts that raw feature into the abstracted feature only with relevant information. That abstracted feature is mapped to the activity embedding space in Step 3 (block 106), then less dominant signals will be stored into the TP distribution or FP distribution in Step 4 (block 108) by comparing with the ground truth (block 110), and the corresponding TP or FP model for the Activity Class Embedding is updated (block 112). FIG. 2 shows and embodiment for the testing (and runtime) process using the trained models. Step 1 through Step 3 are the same as the steps in the training process of FIG. 1. In Step 4 (block 114), the result in the embedding space is compared with the trained TP/FP distributions, and if it is too close to the FP distribution, the recognition result is disregarded, otherwise the recognition result is output (block 116).

The scene graph generation and the feature abstraction steps in FIGS. 1 and 2 are well understood by those skilled in the art such as described in Rahimi, A. Agarwal, K. Lee, H. Kwon and R. Bhattacharyya, “Toward Improving the Visual Characterization of Sport Activities with Abstracted Scene Graphs,” IEEE Conference on Computer Vision and Pattern Recognition: Workshop on Computer Vision in Sports, 2021.

In one embodiment, a video understanding model recognizes semantic dependencies between hypothesized actions and the associated temporal context such as objects and their relations around the time that action is taking place. For instance, if a person is swinging a baseball bat in a cluttered garage scene, the label “swinging a baseball bat” should ignore objects such as “chair”, “car”, or “fan” and rather encode “bat” and “sports ball” in the feature representation for that scene. The video understanding model includes capturing of such dependencies between the actions performed by each person in the scene and the associated objects and relations while the actions are taking place.

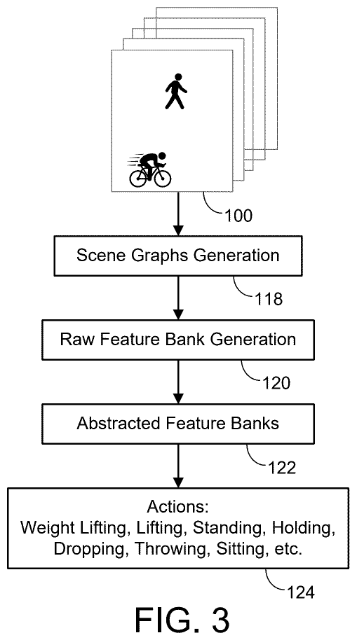

FIG. 3 illustrates an embodiment for the scene graph generation and feature abstraction steps 1 and 2 of both FIGS. 1 and 2 (blocks 118, 120 and 122):
(1) Scene-graph feature bank generation is the initial stage of the process, where for each video frame fᵢ, all objects, O={o₁, o₂, o₃, . . . , oₙ}, and all relations, R={{r₁₁, r₁₂, . . . }, {r₂₁, r₂₂, . . . }}, are captured between all detected actors in the scene such that r_{pq} is the relation between the pₜₕ object oₚ and the q^{th} object o_{q}.
(2) Select only the relations for which class of either the subject or the object in the subject-relation-object triplet is a person.
(3) Furthermore, obtain the associated confidence probabilities for the prediction of each objects {s₁, s₂, . . . } and relations {s₁₁, s₁₂, . . . , s₂₁, s₂₂, . . . }.
(4) Given the confidences scores of the objects and relations associated with each person, construct a confidence map Cᵢⱼ=sᵢ*sᵢⱼ which captures the confidence for each combination of object relation for a given actor in the scene.
(5) Flatten each matrix C to generate each element of the scene graph feature bank F_{SG}=[f₁, f₂, . . . , f_{T}], where T is the total number of time steps while fₜ is the flattened C matrix for time t.
(6) Given a video sequence V and a set of action labels L, assign the label Iₜ to each partial sequential clip vₜ.
(7) The Activity Class Embedding may be performed on a small duration of the videos. According to one embodiment, the classification framework trains an attention-based neural network that references the short-term information to the long-term information using a combination of 3D CNN features and the scene graph feature banks F_{SG} as described in Tang, Kaihua, et al., “Unbiased scene graph generation from biased training,” Proceedings of the IEEE/CVF Conference on Computer Vision and Pattern Recognition, 2020.
(8) For the raw feature vectors that are generated, the process may semantically abstract them using one of four methods referred to as: Conditional Random Field, Canonical Correlation Analysis, Global Context, or Principal Component Analysis, which are described in Rahimi, A. Agarwal, K. Lee, H. Kwon and R. Bhattacharyya, “Toward Improving the Visual Characterization of Sport Activities with Abstracted Scene Graphs,” IEEE Conference on Computer Vision and Pattern Recognition: Workshop on Computer Vision in Sports, 2021.

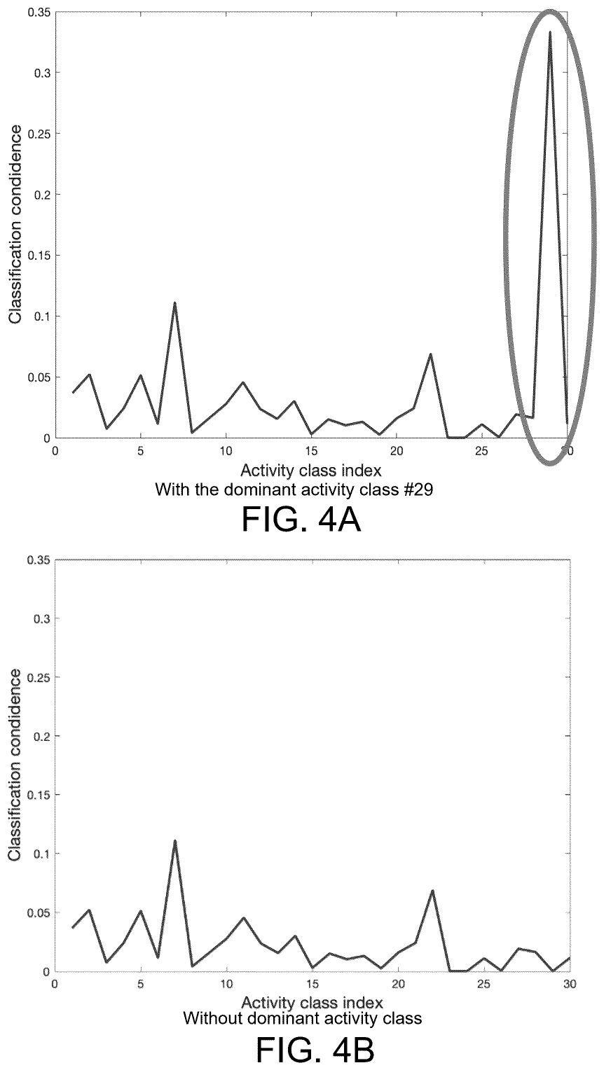

The embedding from the generated feature bank (such as from the abstraction, but it does not need to be abstracted) is mapped into activity class distribution (block 124). The Activity Class Embedding such as 3D CNN (Step 3 in FIGS. 1 and 2) generates the activity class vector as illustrated in FIG. 4A, which is the “embedding space” (at step 3 in both FIGS. 1 and 2) that is processed according to an embodiment. Referring to the embodiment shown in FIG. 4A, an example embedding space includes 30 activity classes, and Activity class #29 is illustrated as dominant and the system classifies that the video clip represents Activity class #29.

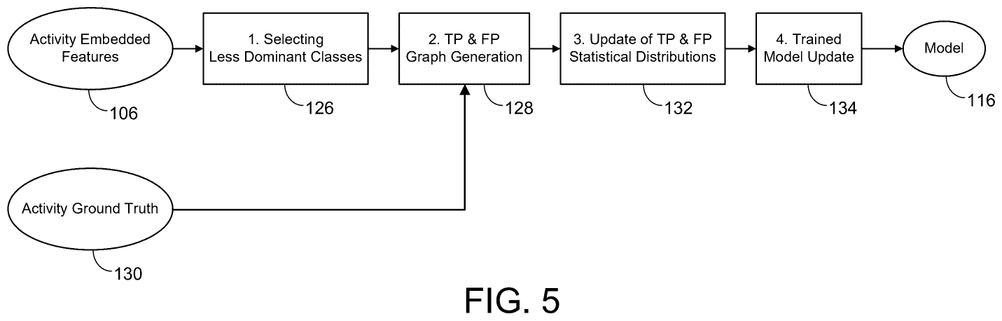

However, the recognition of a dominant activity class such as Activity class #29 may not always be correct and could be an error. There are wrong recognitions (false positives), and the disclosed embodiments illustrate steps to pick out those wrong recognitions out of the collection of the correct/wrong recognitions. In one embodiment, the training process trains the picking out criteria at Step 4 in FIG. 1 which is illustrated in more detail in an embodiment shown in FIG. 5.

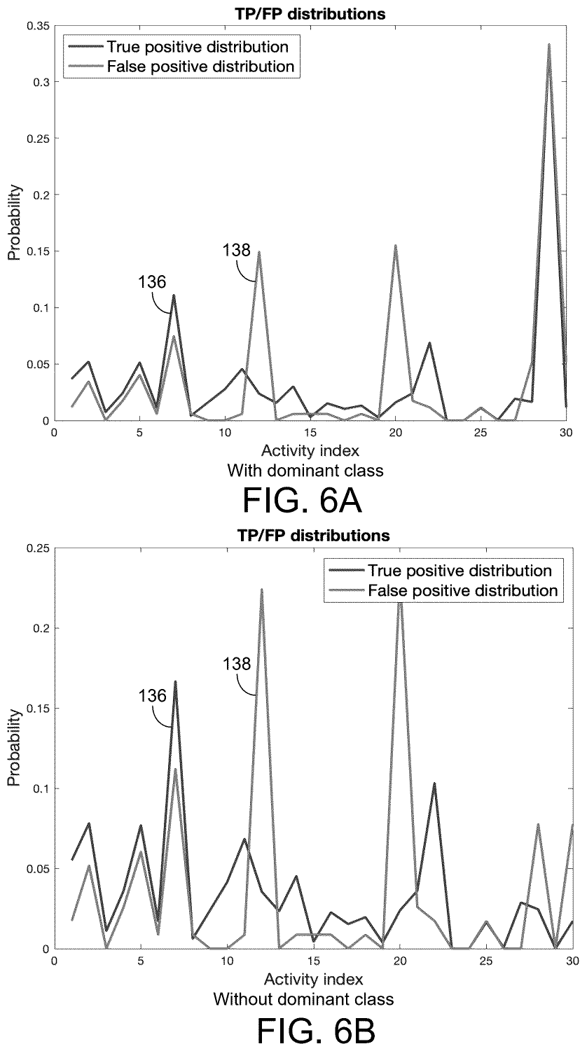

Whether it is true positive recognition or false positive recognition, for a certain activity, in one embodiment the dominant class in the result signal should be the same such as shown in FIG. 6A. Accordingly, Step 1 (block 126) of FIG. 5 is to focus the TP/FP analysis in the embedding space on less dominant signal portions (S_{LD}) by suppressing the main class signal (S_{D}) from the original signal (S) as shown in FIG. 4B.

$${S}_{L D} = S - {S}_{D} \qquad ( 1 )$$

For all collected S_{LD}'s for each activity class, Step 2 (block 128) of FIG. 5 divides them into the true positive collection and the false positive collection using ground truth class labels (block 130). Step 3 (block 132) of FIG. 5 generates the TP distribution:

$${f}_{T P}^{C} ( {S}_{L D} ) \qquad ( 2 )$$

and FP distribution:

$${f}_{F P}^{C} ( {S}_{L D} ) \qquad ( 3 )$$

for Class C. From the two corresponding distributions, the TP/FP analysis finds if the discrepancy between them is sufficiently, statistically meaningful. In one embodiment, the TP/FP analysis may use Bhattacharyya distance, d_{C} (equation shown below) between the two distributions (consider each class index (i^{th} index) independent) as described in Bhattacharyya, A., “On a measure of divergence between two statistical populations defined by their probability distributions,” Bulletin of the Calcutta Mathematical Society 35:99-109 (1943).

$${d}_{C} = {\sum }_{i = 1}^{n} {B}_{i} ( {f}_{T P}^{C} ( {S}_{L D} ) , {f}_{F P}^{C} ( {S}_{L D} ) ) \qquad ( 4 )$$

When d_{C}>Th where Th is the statistical different threshold, the TP/FP analysis will determine that this class's TP/FP distributions are sufficiently different to remove or disregard the false positive classification results. Then accordingly, Step 4 (block 134) of FIG. 5 updates the trained models (block 116). If statistically sufficient discrepancy exists between the distributions, the visual differences can be shown as illustrated in FIG. 6B. In FIG. 6B, the strong signals from TP distribution 136 and FP distribution 138 after suppressing the dominant class are different from each other (Activities 7 and 22 for TP distribution 136 and activities 12 and 20 for FP distribution 138). For example, the TP/FP distributions are sufficiently different if the standard deviations of TP and FP distributions are std_t and std_f, respectively, and the distance between TP/FP means is more than std_t+std_f.

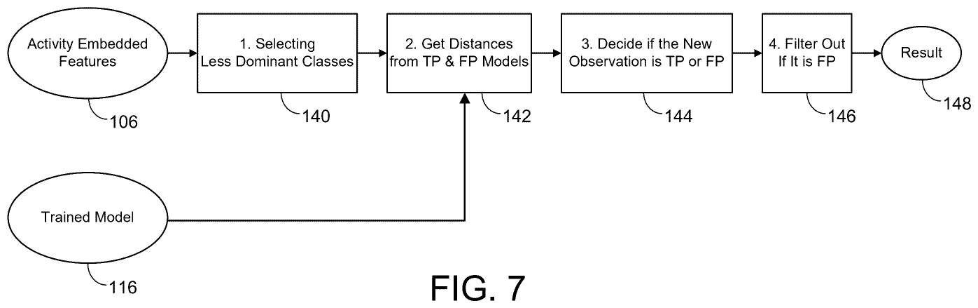

After the TP/FP models are determined for all the corresponding classes, they are applied to the online classification. That testing (and runtime) process is Step 4 (block 114) in FIG. 2, the details of which are described according to an embodiment shown in FIG. 7.

In one embodiment, as in the training process, the testing (and runtime) process acquires S_{LD} by suppressing the dominant class (Step 1 at block 140 in FIG. 7). Then given S_{LD}, the Mahalonobis distances (e.g., described in Mahalanobis, Prasanta Chandra, “Analysis of race mixture in Bengal, Journal and Proceedings of the Asiatic Society of Bengal, 23:301-333 (1927)) from the TP distribution and the FP distribution in the class embedding space are calculated (Step 2 at block 142 in FIG. 7). If the ratio of the two Mahalonobis distances is larger than the threshold, Th_{FP} (Step 3 at block 144 in FIG. 7), the testing process disregards the corresponding signal (Step 4 at block 146 in FIG. 7). Wrong classification if:

$$\frac{{M}_{T P}^{C} ( {S}_{L D} )}{{M}_{F P}^{C} ( {S}_{L D} )} > T {h}_{F P}^{C} \qquad ( 5 )$$

where M_{FP}^{C}(S_{LD}) is S_{LD}'S Mahalonobis distance from the false positive distribution for Class C, M_{TP}^{C}(S_{LD}) is S_{LD}'S Mahalonobis distance from the true positive distribution for Class C, and Th_{FP}^{C} is the corresponding ratio threshold which determines whether the Activity Class Embedding detected a wrong classification or not. After this entire process, if the final classification result is confirmed the result is output at block 148. In one embodiment, the threshold Th_{FP} can indicate the location that TP/FP probabilistic distribution amounts are the same.

Referring to equation (1) above, any suitable technique may be used to suppress the dominant class (S_{D}) from the original signal (S) when training the Activity Class Embedding in order to generate a TP model (e.g., TP trained weights) corresponding to the TP distribution and a FP model (e.g., FP trained weights) corresponding to the FP distribution. In one embodiment in order to train the TP model, training activity class signals known to be TP for each target class (Cᵢ) are processed by the Activity Class Embedding, wherein the Activity Class Embedding is adapted so as to maximize the accumulated probabilities for the less dominant classes. Similarly in order to train the FP model, training activity class signals known to be FP for each target class (Cᵢ) are processed by the Activity Class Embedding, wherein the Activity Class Embedding is adapted so as to maximize the accumulated probabilities for the less dominant classes. In one embodiment after training the TP/FP models, a number of TP/FP distributions are generated by processing training activity class signals using the trained models in order to generate a number of corresponding test TP/FP distributions which are further processed to generate the final TP/FP distributions. For example, in one embodiment the final TP/FP distributions may be generated by averaging the test TP/FP distributions, wherein in one embodiment the averaging is performed by averaging the respective class probabilities generated by the TP/FP trained models. This process is repeated for each activity class in order to generate a trained TP/FP model for each activity class, as well as a corresponding TP/FP distribution for each activity class.

In one embodiment, when testing the accuracy of the FP removal filtering (as well as during runtime), a test activity class signal (S) is processed by the computer system of FIG. 2 including the Activity Class Embedding which outputs a probability for each activity class (where the activity class having the highest probability is the detected dominant activity class). In order to determine whether the classification is a FP, the test activity class signal (S) is processed (at Step 4 of FIG. 2) by the TP trained model corresponding to the detected class in order to generate a corresponding TP class probability distribution (referred to as a test true positive or TTP class probability distribution), and processed by the FP trained model corresponding to the detected class in order to generate a corresponding FP class probability distribution (referred to as a test false positive or TFP class probability distribution). In one embodiment, the probability for the detected class in the TTP/TFP class probability distributions is “zeroed” in order to suppress the detected (dominant) class from these distributions. Once the dominant-class-zeroed distribution is generated, in order to make it satisfied with the characteristics of probabilistic distribution, a normalization procedure is performed to that distribution. With that normalization procedure, the summation of each suppressed distribution becomes one. The resulting TTP/TFP distributions are then compared to the TP/FP distributions (e.g., by measuring the Mahalonobis distances) in order to determine whether the class detected by the Activity Class Embedding from the test activity class signal (S) is a FP which should be filtered out as described above with reference to equation (5).

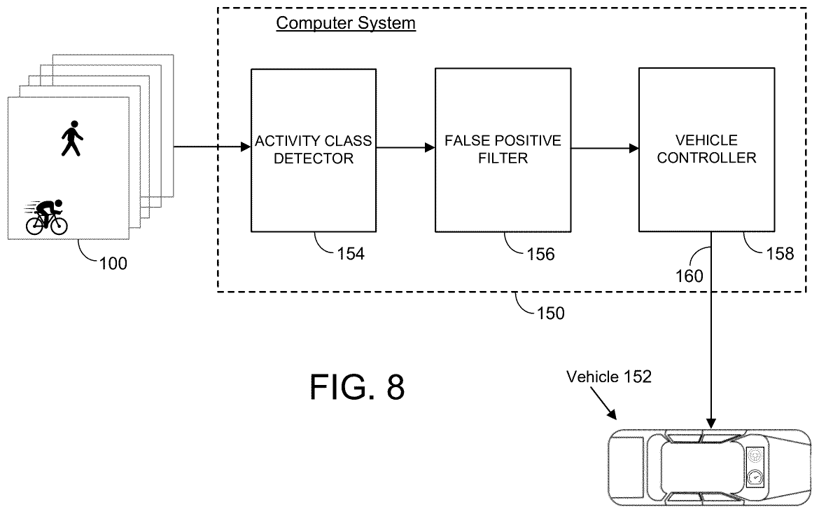

FIG. 8 shows an embodiment of a computer system 150 for processing a runtime activity class signal 100 comprising a dominant activity class and a plurality of less dominant activity classes in order to control a vehicle 152. The computer system 150 comprises a runtime activity class detector 154 such as described above, trained to detect the dominant activity class in the runtime activity class signal 100. A false positive (FP) filter 156 is configured to filter out FP classifications detected by the activity class detector 154, wherein the FP filter 156 is trained based on the less dominant activity classes in the runtime activity class signal 100. A computer implemented vehicle controller 158 is configured to generate a vehicle control signal 160 based on the detected dominant activity class, wherein the vehicle control signal 160 for controlling at least one of a steering or speed of the vehicle. The vehicle shown in the embodiment of FIG. 8 is an automobile; however, any suitable vehicle may be controlled using the machine vision network embodiments disclosed herein, such as aircraft, drones, missiles, robots, etc.

In one embodiment, the computer system in the above described embodiments comprises one or more processors configured to perform calculations, processes, operations, and/or functions associated with a program or algorithm. The processes and steps in the example embodiments may be instructions (e.g., software program) that reside within a non-transitory computer readable memory executed by the one or more processors of computer system. When executed, these instructions cause the computer system to perform specific actions and exhibit specific behavior for the example embodiments disclosed herein. The processors may include one or more of a single processor or a parallel processor, an application-specific integrated circuit (ASIC), programmable logic array (PLA), complex programmable logic device (CPLD), or a field programmable gate array (FPGA).

The computer system may be configured to utilize one or more data storage units such as a volatile memory unit (e.g., random access memory or RAM such as static RAM, dynamic RAM, etc.) coupled with address/data bus. Also, the computer system may include a non-volatile memory units (e.g., read-only memory (“ROM”), programmable ROM (“PROM”), erasable programmable ROM (“EPROM”), electrically erasable programmable ROM “EEPROM”), flash memory, etc.) coupled with an address/data bus. A non-volatile memory unit may be configured to store static information and instructions for a processor. Alternatively, the computer system may execute instructions retrieved from an online data storage unit such as in “Cloud” computing.

The computer system may include one or more interfaces configured to enable the computer system to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

The computer system may include an input device configured to communicate information and command selections to a processor. Input device may be an alphanumeric input device, such as a keyboard, that may include alphanumeric and/or function keys. The computer system may further include a cursor control device configured to communicate user input information and/or command selections to a processor. The cursor control device may be implemented using a device such as a mouse, a track-ball, a track-pad, an optical tracking device, or a touch screen. The cursor control device may be directed and/or activated via input from an input device, such as in response to the use of special keys and key sequence commands associated with the input device. Alternatively, the cursor control device may be configured to be directed or guided by voice commands.

The processes and steps for the example may be stored as computer-readable instructions on a compatible non-transitory computer-readable medium of a computer program product. Computer-readable instructions include a set of operations to be performed on a computer, and may represent pieces of a whole program or individual, separable, software modules. For example, computer-readable instructions include computer program code (source or object code) and “hard-coded” electronics (i.e. computer operations coded into a computer chip). The computer-readable instructions may be stored on any non-transitory computer-readable medium, such as in the memory of a computer or on external storage devices. The instructions are encoded on a non-transitory computer-readable medium.

A number of example embodiments have been described. Nevertheless, it will be understood that various modifications may be made without departing from the spirit and scope of the devices and methods described herein.

What is claimed is:

1. A computer system for processing a runtime activity class signal comprising a dominant activity class and a plurality of less dominant activity classes, the computer system comprising:
a computer implemented runtime activity class detector trained to detect the dominant activity class in the runtime activity class signal; and
a computer implemented false positive (FP) filter configured to filter out FP classifications detected by the runtime activity class detector, wherein the FP filter is trained based on the less dominant activity classes in the runtime activity class signal.

2. The computer system as recited in claim 1, wherein the FP filter comprises:
a computer implemented true positive (TP) activity class detector trained on TP activity class signals so as to suppress a target dominant activity class in the TP activity class signals; and
a computer implemented FP activity class detector trained on FP activity class signals so as to suppress the target dominant activity class in the FP activity class signals.

3. The computer system as recited in claim 2, wherein the FP filter further comprises:
a plurality of the computer implemented TP activity class detectors each corresponding to a target dominant activity class out of a plurality of dominant activity classes; and
a plurality of the computer implemented FP activity class detectors each corresponding to the target dominant activity class out of the plurality of dominant activity classes.

4. The computer system as recited in claim 2, wherein the FP filter further comprises:
a TP distribution generated by the TP activity class detector processing TP activity class signals; and
a FP distribution generated by the FP activity class detector processing FP activity class signals.

5. The computer system as recited in claim 4, wherein the FP filter is further configured to:
process the runtime activity class signal using the TP activity class detector to generate a test TP (TTP) distribution;
process the runtime activity class signal using the FP activity class detector to generate a test FP (TFP) distribution; and
detect the FP classification by comparing the TTP distribution to the TP distribution and comparing the TFP to the FP distribution.

6. The computer system as recited in claim 5, wherein the FP filter is further configured to:
measure a first distance between the TTP distribution and the TP distribution;
measure a second distance between the TFP distribution and the FP distribution; and
detect the FP classification when a ratio of the first distance to the second distance exceeds a threshold.

7. The computer system as recited in claim 5, wherein the FP filter is further configured to:
zero the dominant activity class in the TTP distribution prior to comparing the TTP distribution to the TP distribution; and
zero the dominant activity class in the TFP distribution prior to comparing the TFP distribution to the FP distribution.

8. A computer implemented method for processing a runtime activity class signal comprising a dominant activity class and a plurality of less dominant activity classes, the method comprising:
using a computer to detect the dominant activity class in the runtime activity class signal; and
using the computer to filter out false positive (FP) classifications of the detected dominant activity class based on the less dominant activity classes in the runtime activity class signal.

9. The computer implemented method as recited in claim 8, wherein filtering out the FP classifications comprises:
using the computer to train a true positive (TP) activity class detector on TP activity class signals so as to suppress a target dominant activity class in the TP activity class signals; and
using the computer to train a FP activity class detector on FP activity class signals so as to suppress the target dominant activity class in the FP activity class signals.

10. The computer implemented method as recited in claim 9, wherein filtering out the FP classifications further comprises:
using the computer to train a plurality of the TP activity class detectors each corresponding to a target dominant activity class out of a plurality of dominant activity classes; and
using the computer to train a plurality of the FP activity class detectors each corresponding to the target dominant activity class out of the plurality of dominant activity classes.

11. The computer implemented method as recited in claim 9, wherein filtering out the FP classifications further comprises:
using the computer to generate a TP distribution by processing TP activity class signals; and
using the computer to generate a FP distribution by processing FP activity class signals.

12. The computer implemented method as recited in claim 11, wherein filtering out the FP classifications further comprises:
using the computer to process the runtime activity class signal to generate a test TP (TTP) distribution;
using the computer to process the runtime activity class signal to generate a test FP (TFP) distribution; and
using the computer to detect the FP classification by comparing the TTP distribution to the TP distribution and comparing the TFP to the FP distribution.

13. The computer implemented method as recited in claim 12, wherein filtering out the FP classifications further comprises:
using the computer to measure a first distance between the TTP distribution and the TP distribution;
using the computer to measure a second distance between the TFP distribution and the FP distribution; and
using the computer to detect the FP classification when a ratio of the first distance to the second distance exceeds a threshold.

14. The computer implemented method as recited in claim 12, wherein filtering out the FP classifications further comprises:
using the computer to zero the dominant activity class in the TTP distribution prior to comparing the TTP distribution to the TP distribution; and
using the computer to zero the dominant activity class in the TFP distribution prior to comparing the TFP distribution to the FP distribution.

15. A computer system for processing a runtime activity class signal comprising a dominant activity class and a plurality of less dominant activity classes in order to control a vehicle, the computer system comprising:
a computer implemented runtime activity class detector trained to detect the dominant activity class in the runtime activity class signal;
a computer implemented false positive (FP) filter configured to filter out FP classifications detected by the runtime activity class detector, wherein the FP filter is trained based on the less dominant activity classes in the runtime activity class signal; and
a computer implemented vehicle controller configured to generate a vehicle control signal based on the detected dominant activity class, wherein the vehicle control signal for controlling at least one of a steering or speed of the vehicle.

16. The computer system as recited in claim 15, wherein the FP filter comprises:
a computer implemented true positive (TP) activity class detector trained on TP activity class signals so as to suppress a target dominant activity class in the TP activity class signals; and
a computer implemented FP activity class detector trained on FP activity class signals so as to suppress the target dominant activity class in the FP activity class signals.

17. The computer system as recited in claim 16, wherein the FP filter further comprises:
a plurality of the computer implemented TP activity class detectors each corresponding to a target dominant activity class out of a plurality of dominant activity classes; and
a plurality of the computer implemented FP activity class detectors each corresponding to the target dominant activity class out of the plurality of dominant activity classes.

18. The computer system as recited in claim 16, wherein the FP filter further comprises:
a TP distribution generated by the TP activity class detector processing TP activity class signals; and
a FP distribution generated by the FP activity class detector processing FP activity class signals.

19. The computer system as recited in claim 18, wherein the FP filter is further configured to:
process the runtime activity class signal using the TP activity class detector to generate a test TP (TTP) distribution;
process the runtime activity class signal using the FP activity class detector to generate a test FP (TFP) distribution; and
detect the FP classification by comparing the TTP distribution to the TP distribution and comparing the TFP to the FP distribution.

20. The computer system as recited in claim 19, wherein the FP filter is further configured to:
measure a first distance between the TTP distribution and the TP distribution;
measure a second distance between the TFP distribution and the FP distribution; and
detect the FP classification when a ratio of the first distance to the second distance exceeds a threshold.
